(19) United States
(12) Patent Application Publication
(10) Pub. No.: US 2019/0052374 A1
(43) Pub. Date: Feb. 14, 2019

(54) Calibrating A Digital Telemetry System

(71) Applicant: Halliburton Energy Services, Inc., Houston, TX (US)

(72) Inventors: Joni Polili Lie, Singapore (SG); Yifei Yang, Singapore (SG); Alberto Quintero, Houston, TX (US); Roy Tan, Singapore (SG)

(21) Appl. No.: 15/570,601

(22) PCT Filed: Oct. 11, 2016
(86) PCT No.: PCT/US2016/056403

§ 371 Date: Oct. 30, 2017

(51) Int. Cl. H04B 17/21; E21B 47/12; H04B 17/11; H04B 17/24; H04B 17/345; H04L 27/38

(52) U.S. Cl. CPC H04B 17/21; E21B 47/12; H04B 17/11; H04L 2027/0026; H04B 17/345; H04L 27/38; H04B 17/24

(57) ABSTRACT

A digital telemetry system can be calibrated to improve data communication. A receiver can receive a modulated signal with a predetermined sequence of transmitted symbols. A processing device can be communicatively coupled to the receiver for jointly performing carrier phase synchronization and symbol-timing recovery on the modulated signal to determine a corrective phase offset and a corrective timing offset. The receiver can be calibrated to use the corrective phase offset and the corrective timing offset for demodulating a subsequently modulated signal. In additional or alternative aspects, a demodulator can demodulate the modulated signal and determine an amount of interference introduced to the modulated signal. A transmitter can transmit data based on the amount of interference to a modem that transmitted the modulated signal for use by the modem to dynamically adjust hit allocation of the subsequently modulated signal.

### TECHNICAL FIELD

The present disclosure relates generally to a telemetry system, and more particularly (although not necessarily exclusively), to calibrating a digital telemetry system for use in a wellbore environment.

### BACKGROUND

A telemetry system can be used to communicate data collected in a remote location to a receiving device for monitoring and processing. In some examples, a digital telemetry system can be used in a wellbore environment to communicate between a device positioned downhole and a device positioned at the surface. It can be desirable to collect data about a drilling assembly or the wellbore environment contemporaneously with drilling. This can allow the well operator to steer or otherwise optimize performance of the drilling assembly. Collecting data about the drilling assembly or the subterranean formation while drilling can be known as measuring while drilling (“MWD”) or logging while drilling (“LWD”).

MWD or LWD systems can employ mud pulse telemetry to transmit the data to the surface of the well system. Mud pulse telemetry can use a drilling fluid (e.g., mud) within the drilling assembly as a communication medium. One form of mud pulse telemetry can be positive pulse telemetry, in which a valve can restrict the flow of the drilling fluid through the drilling assembly. This can create a pressure pulse. Another form of mud pulse telemetry can be negative pulse telemetry, in which a valve releases drilling fluid from within the drilling assembly into an annular space in the wellbore. This can also create a pressure pulse. Using either of the above forms of mud pulse telemetry, the pressure pulse can propagate through the drilling fluid at the speed of sound, where it can be detected at the surface of the well system. In this manner, MWD or MD systems can transmit data encoded in pressure pulses to the surface of the well system.

Digital implementations of a telemetry system can be used to provide communication between a device positioned downhole and a device positioned at the surface. But some approaches, including discrete multitone modulation (“DMT”), orthogonal frequency-division multiplexing (“OFDM”), amplitude-shift keying (“ASK”), phase-shift keying (“PSK”), and frequency-shift keying (“FSK”), can involve employing uniform bandwidth across a regular interval carrier frequency. These approaches can use a small carrier frequency interval that can increase the number of sub-bands as well as the computational complexity required for modulating and demodulating signals.

### BRIEF DESCRIPTION OF THE DRAWINGS

FIG. 1 is a cross-sectional diagram of an example of a wellbore with a wireline digital telemetry system according to one aspect of the present disclosure.

FIG. 2 is a cross-sectional diagram of an example of a wellbore with a wireless digital telemetry system according to one aspect of the present disclosure

FIG. 3 is a block diagram of an example of a digital telemetry system according to one aspect of the present disclosure.

FIG. 4 is a block diagram of an example of a transmitter in a digital telemetry system according to one aspect of the present disclosure,

FIG. 5 is a block diagram of an example of a receiver in a digital telemetry system according to one aspect of the present disclosure.

FIG. 6 is a block diagram of an example of a decision feedback-based synchronization circuit according to one aspect of the present disclosure.

FIG. 7 is a block diagram of an example of a symbol-timing recovery circuit according to one aspect of the present disclosure.

FIG. 8 is a flow chart of an example of a process for performing carrier phase synchronization and symbol-timing recovery jointly for a digital telemetry system according to one aspect of the present disclosure.

FIG. 9 is a flow chart of an example of a process for calibrating a digital telemetry system through channel analysis and dynamic bit allocation according to one aspect of the present disclosure.

FIG. 10 is a graph showing a frequency spectrum in which calibration of the digital telemetry system has detected frequency bands with high interference according to one aspect of the present disclosure.

FIG. 11 is a graph showing a frequency spectrum after calibrating a digital telemetry system using dynamic bit allocation of usable frequencies according to one aspect of the present disclosure.

FIG. 12 is a graph showing a frequency spectrum after calibrating a digital telemetry system by grouping neighboring sub-bands according to one aspect of the present disclosure.

### DETAILED DESCRIPTION

Certain aspects and features relate to calibrating a digital telemetry system. A modulated signal can be altered during transmission (e.g., due to environmental noise), which can reduce an ability of a receiver to accurately and efficiently extract data from the modulated signal. Calibrating the digital telemetry system can include adjusting a transmitter or a receiver in the digital telemetry system based on detected interference to compensate or adjust for the interference so that the receiver can more accurately extract data from signals while using a high data rate. Calibrating the digital telemetry system can include estimating the carrier phase and symbol timing jointly to determine a phase offset and a timing offset for use in demodulating modulated signals. In additional or alternative aspects, calibrating the digital telemetry system can include dynamically adjusting bit allocation for subsequently modulated signals in response to interference affecting specific frequency bands. Dynamically adjusting the bit allocation can allow for data to be transmitted in frequency bands that avoid interference and can reduce the processing requirements of the receiver by reducing the number of bands being used for data communication.

In some aspects, a digital telemetry system can transmit remotely collected data in the form of an electrical signal over a high-powered wireline cable to a receiver for acquisition, monitoring, and interpretation. For example, a digital telemetry system can be a monocable telemetry system used for data acquisition in oilfield operations with a downhole modem that is transmitting tool data to a surface modem. At the same time, the surface modem can transmit commands to the downhole modern to be delivered to specific logging tools for operation or execution. In additional or alternative aspects, a digital telemetry system can transmit remotely collected data in the form of wireless signals. For example, a digital telemetry system can use mud-pulse telemetry to communicate using pressure waves. In some examples, transmissions can include modulation of the data and up-converting to a carrier frequency. Receivers can reverse the process by down-converting and demodulating to recover the data.

System reliability can be reduced by introducing a phase offset and timing offset during transmission (e.g., due to environmental noise). In some telemetry systems used in downhole logging operations, synchronization between the surface modem and the downhole modem can be accomplished by sending a train of rectangular pulses at a regular interval and monitoring a reflected signal. The telemetry system can calculate the signal propagation delay and offset using a clock. But, the reliability of the calculation presumes an accurate detection of the rectangular pulse and a noise-free environment during synchronization. In addition, the overall synchronization process can take a substantial amount of time and re-synchronization can increase overhead of the communication system.

Jointly performing carrier phase synchronization and symbol-timing recovery can reduce communication errors by determining the phase offset and the timing offset to allow the receiver to compensate for interference (from environmental conditions or otherwise) and recover the data Jointly performing carrier phase synchronization and symbol-timing recovery can include receiving a modulated signal with a predetermined sequence of transmitted symbols. The modulated signal can be demodulated based on an estimated phase offset and an estimated timing offset to determine a sequence of received symbols. The estimated phase offset and the estimated timing offset can be updated based on differences between the predetermined sequence of transmitted symbols and the sequence of received symbols.

In some aspects, a wireline digital telemetry system used in a wellbore environment can have bandwidth limitations. In some examples, downhole electric motors and other downhole tools can use the same wireline used by a wireline digital telemetry system. In additional or alternative examples, bandwidth can be limited based on variations in cable attenuation (e.g., due to cable length). In additional or alternative aspects, a wireless digital telemetry system used in a wellbore environment can have bandwidth limitations. In some examples, downhole tools (e.g., motors or drills) can create electromagnetic fields and acoustic waves that can interfere with the wireless signals. In additional or alternative examples, bandwidth can be limited based on variation in the communication medium (e.g., due to mud density or depth). Communication across the digital telemetry system can be improved by dynamically calibrating frequency, bandwidth, and bit allocation of transmitted modulated signals, based on the wellbore environment and properties of the communication medium (e.g., wireline or mud).

In some aspects, frequency, bandwidth, and bit allocation can be dynamically calibrated using a multi-band quadrature amplitude modulation (“QAM”). Multi-band QAM can include dynamic bit allocation to enable the digital telemetry system to better use the bandwidth provided by the communication medium. Dynamic bit allocation can include varying the bits communicated in each frequency band of a modulated signal. Allocating fewer bits to a frequency band with high interference can reduce the bit error rate and reduce the processing performed by a receiver. Allocating more bits to a frequency band with lower interference can increase the bit rate and reliability of the system. In additional or alternative aspects, multi-band QAM can allow a digital telemetry system to be calibrated by adjusting a carrier frequency to avoid interference (e.g., interference from electric motors). In some aspects, calibrating a digital telemetry system can be performed on-the-fly or based on the real-time operating conditions of the telemetry system. The receiver can perform demodulation of the received time-varying signal to recover transmitted data Unlike the discrete multi-tone (“DMI”) modulation scheme, the multi-band QAM can employ non-uniform bandwidth across a regular interval carrier frequency. For example, multi-band QAM can allow for calibrating a digital telemetry system to transmit modulated signals with a varying number of frequency sub-bands and without any unused frequency bands.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative aspects but, like the illustrative aspects, should not be used to limit the present disclosure.

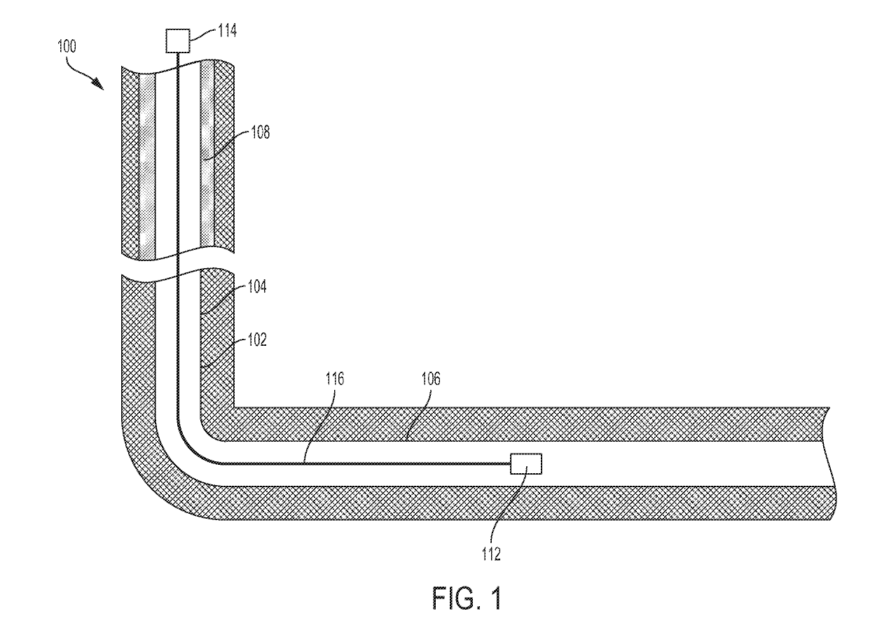

FIG. 1 is a cross-sectional diagram of an example of a well assembly 100 with a digital telemetry system using a wireline 116. The well assembly 100 includes a wellbore 102 that extends through various earth strata The wellbore 102 has a substantially vertical section 104 and a substantially horizontal section 106. The substantially vertical section 104 and the substantially horizontal section 106 can include a casing string 108 cemented at an upper segment of the substantially vertical section 104.

The digital telemetry system can include a downhole modem 112 communicatively coupled to a surface modem 114. The downhole modem 112 can be located in the horizontal section 106 and can be coupled to the tubing string 110. The surface modem 114 can be located at the surface of the wellbore 102, and is communicatively coupled to the downhole modem 112 by the wireline 116. In some aspects, signals can be communicated between the downhole modem 112 and the surface modem 114. In some examples, the downhole modem 112 can be communicatively coupled to one or more downhole tools. The surface modem 114 can transmit instructions to the downhole modem 112 to be delivered to a specific tool. In additional or alternative examples, the downhole modem 112 can transmit data from a downhole tool or data about the downhole tool to the surface modem 114. In sonic examples, the signals can be modulated and up-converted to a carrier frequency. The downhole modem 112 and the surface modem 114 can each include a receiver to down-convert and demodulate the signal to obtain the transmitted data.

In some aspects, phase modulation can be used to modulate the signal, and interference (e.g., noise) :an cause the received modulated signal to have a phase offset and timing offset. The receiver can include a processing device and demodulator for jointly performing carrier phase synchronization and symbol-timing recovery to determine the phase offset and the timing offset. Calibrating the receiver using the phase offset and the timing offset can allow the receiver to accurately demodulate a signal modulated using phase modulation.

In additional or alternative aspects, the downhole modem and the surface modem can detect interference in specific frequency bands of a modulated signal. Calibrating a transmitter based on the interference can include determining dynamic bit allocation for subsequently modulated signals so as to best use available bandwidth. In some aspects, subsequently modulated signals can include modulated signals transmitted subsequent in time to the transmitter obtaining data describing the interference. In additional or alternative aspects, subsequently modulated signals can include modulated signals transmitted subsequent in time to the transmitter transmitting a calibration signal (e.g., a signal used by a receiver to determine the interference)

Although FIG. 1 depicts the digital telemetry system using a wireline, a digital tel system can use any wired or wireless communication medium. A digital telemetry system can be used with a wellbore during any part of the life cycle of the wellbore (e.g., drilling, completion, and production). In some aspects, a digital telemetry system can be used with a tubing string in a wellbore. In additional or alternative aspects, a wellbore can include more than one digital telemetry system. In additional or alternative aspects, the digital telemetry system can be positioned in a simpler wellbore, such as a wellbore having only a vertical section. In some examples, a digital telemetry system can be positioned in an open-hole environment or in a cased well. In additional or alternative examples, a downhole modem can be positioned in a substantially vertical section of a wellbore.

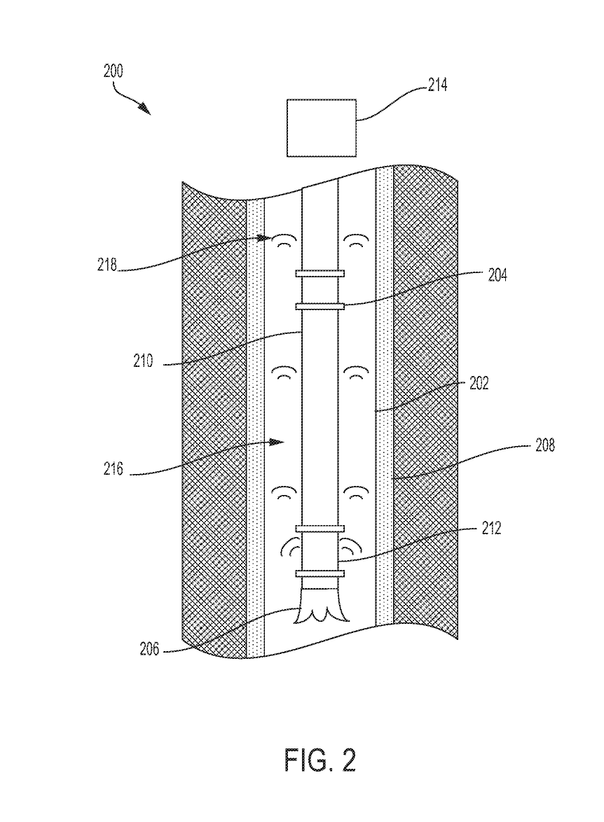

FIG. 2 is a cross-sectional diagram of a well assembly 200 with a digital telemetry system using wireless signals 218. The well assembly 200 includes a wellbore 202 that extends through various earth strata The wellbore 202 can include a casing string 208. A well tool 210 (e.g., a drill string) can extend from a surface of the wellbore 202 into the wellbore 202. In some examples, the well tool 210 can include a logging while drilling (“LWD”) tool or a measuring while drilling (“MWD”) tool. The well tool 210 can include various tubular sections and subsystems. For example, the well tool 210 can include sensors for determining information about the wellbore 202, the subterranean formation, and the well tool 210 (e.g., drilling parameters). The well tool 210 can also include (or be communicatively coupled to) a downhole modem 212 for communicating data to a surface modem 214 positioned at the surface of the wellbore 202. The well tool 210 can further include a drill bit 206 for drilling the wellbore 202. In some examples, the tubular sections and subsystems can be coupled by tubular joints 204.

Fluid (e.g., mud) can be pumped through the well tool 210 at high pressure. The fluid can flow through ports or jets in the drill bit 206. The fluid can travel through a space 216 (e.g., an annulus) between the well tool 210 and a wall of the wellbore 202 to the surface of the wellbore 202. In some examples, at the surface of the wellbore 202, the fluid can be cleaned and recirculated through the well tool 210.

In some examples, the downhole modem 212 can include a valve. The downhole modem 212 can open and close the valve to modulate the pressure of the fluid in the well tool 202. This can generate the wireless signals 218 as pressure pulses that can propagate through the fluid to the surface of the wellbore 202. The surface modem 214 can convert the pressure pulses into electric signals such that the surface modem 214 can wirelessly communicate with the downhole modem 212.

In additional or alternative examples, the downhole modem 212 can wirelessly communicate with the surface modem 214 using electromagnetic signals or acoustic signals. In some aspects, the downhole modem 212 can be communicatively coupled to one or more downhole tools. The surface modem 214 can transmit instructions to the downhole modem 212 to be delivered to a specific tool. In additional or alternative examples, the downhole modem 212 can transmit data from a downhole tool or data about the downhole tool to the surface modem 214. In some examples, the signals can be modulated and up-converted to a carrier frequency. The downhole modem 212 and the surface modem 214 can each include a receiver to down-convert and demodulate the signal to obtain the transmitted data.

In some aspects, phase modulation can be used to modulate the signal, and interference (e.g., noise) can cause the received modulated signal to have a phase offset and timing offset. The receiver can include a processing device and demodulator for jointly performing carrier phase synchronization and symbol-timing recovery to determine the phase offset and the timing offset. Calibrating the receiver using the phase offset and the timing offset can allow the receiver to accurately demodulate a signal modulated using phase modulation.

In additional or alternative aspects, the downhole modem 212 and the surface modem 214 can detect interference in specific frequency bands of a modulated signal. Calibrating a transmitter based on the interference can include determining dynamic bit allocation for subsequently modulated signals so as to best use available bandwidth. In some aspects, subsequently modulated signals can include modulated signals transmitted subsequent in time to the transmitter obtaining data describing the interference. In additional or alternative aspects, subsequently modulated signals can include modulated signals transmitted subsequent in time to the transmitter transmitting a calibration signal (e.g., a signal used by a receiver to determine the interference).

Although FIG. 2 depicts the digital telemetry system positioned with drill string 210, a digital telemetry system can be used separately from a drill string in a wellbore. In some aspects, a wellbore can include more than one digital telemetry system. In additional or alternative aspects, the digital telemetry system can be positioned in a more complex wellbore, such as a multilateral wellbore. In some examples, a digital telemetry system can be positioned in an open-hole environment or in a cased well.

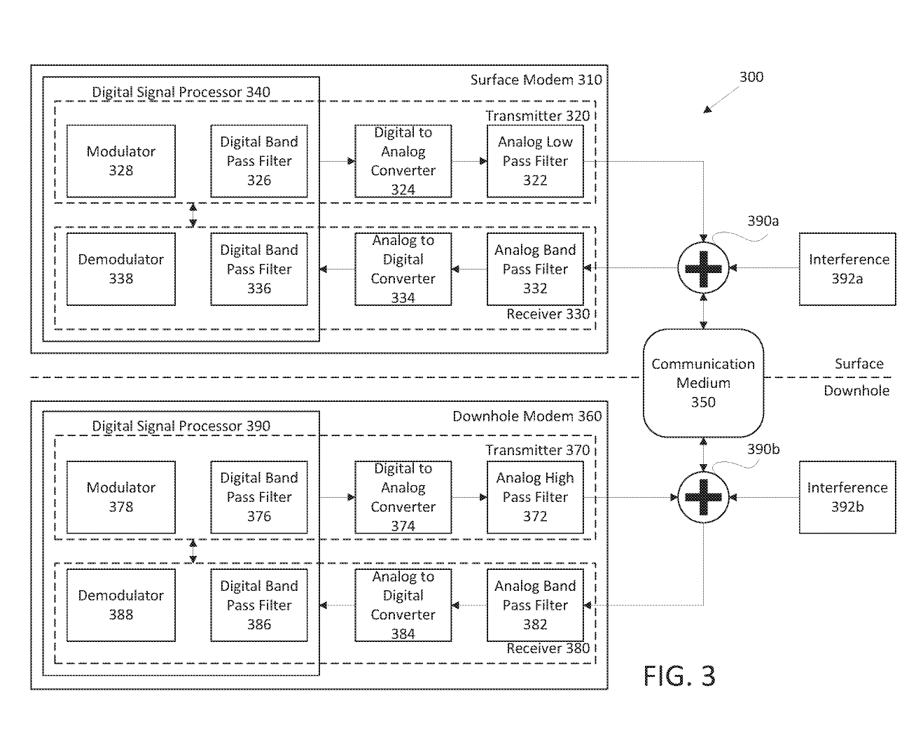

FIG. 3 is a block diagram of an example of a digital telemetry system 300. The digital telemetry system 300 includes a surface modern 310 and a downhole modern 360 communicatively coupled by a communication medium 3.50 (e.g., a wireline or mud). Adders 390a-b are depicted in FIG. 3 to illustrate that interference 392a-b can be introduced into signals that are communicated between the surface modem 310 and the downhole modem 360. In some examples, interference 3926 can include downhole environmental noise such as an electromagnetic field produced by a motor.

Both the surface modem 310 and the downhole modem 360 can include a transmitter 320, 370 for transmitting signals across the digital telemetry system 300 and a receiver 330, 380 for receiving signals transmitted across the digital telemetry system 300. The transmitter 320 in the surface modem 310 can include an analog low pass filter 322. The transmitter 370 in the downhole modem 360 can include an analog high pass filter 372. Both transmitters 320, 370 can include a digital-to-analog converter (“DAC”) 324, 374, a digital band pass filter 326, 376, and a modulator 328, 378. The receivers 330, 380 can each include an analog band pass filter 332, 382, an analog-to-digital converter (“ADC”) 334, 384, a digital band pass filter 336, 386, and a demodulator 338, 388. Both the surface modern 310 and the downhole modem 360 can include a digital signal processor 340, 390. The digital signal processor can include the modulators 328, 378, the demodulators 338, 388, and the digital band pass filters 326, 336, 376, and 386. In some aspects, the surface modem 310 and the downhole modem 360 can include any number of digital signal processors.

The digital signal processors 340, 390 can include any number of processors configured for executing program code. Examples of the digital signal processors 340, 390 can include a microprocessor, an application-specific integrated circuit (“ASIC”), a field-programmable gate array (“FPGA”), or other suitable processor. In some aspects, the digital signal processors 340, 390 can be dedicated processors used for calibrating the digital telemetry system 300. In other aspects, the digital signal processors 340, 390 can perform additional functions for transmitting telemetry data and receiving telemetry data

The digital signal processors 340, 390 can include (or be communicatively coupled with) a non-transitory computer-readable memory. The memory can include one or more memory devices that can store program instructions. The program instructions can include, for example, a calibration engine that is executable by the digital signal processors 340, 390 to perform certain operations described herein.

In some examples, the operations can include receiving a modulated signal including a predetermined sequence of transmitted symbols. The operations can further include jointly performing carrier phase synchronization and symbol-timing recovery on the modulated signal to calculate a corrective phase offset and a corrective timing offset. The operations can further include calibrating the demodulator 338, 388 to use the corrective phase offset and the corrective timing offset for demodulating subsequently modulated signals such that data in the subsequently modulated signals can be recovered despite interference introduced during transmission.

In additional or alternative examples, the operations can include demodulating the modulated signal based on an estimated timing offset to generate a received sequence of received symbols. The operations can further include tracking differences in phase between each received symbol in the received sequence of received symbols and a corresponding transmitted symbol in the predetermined sequence of transmitted symbols, and updating an estimated phase offset based on the differences in phase. The operations can further include determining a number of received symbols, and if the number is less than a majority of the transmitted symbols, adjusting the estimated timing offset. The operations can further include instructing the demodulator 338, 388 to demodulate the modulated signal again based on an adjusted timing offset. The operations can further include computing a symbol value for each received symbol at a series of sample indices. The symbol value for each received signal at each sample index of the series of sample indices can be used to find a peak. The peak can be used to determine an optimal sample index for all symbols and update the estimated timing offset. The operations can further include computing the corrective phase offset and the corrective timing offset based on the estimated phase offset and the estimated timing offset.

In additional or alternative examples, the operations can include determining an amount of interference 392a-b introduced to specific frequency bands of a modulated signal during the transmission of the modulated signal. The operations can further include transmitting data based on the amount of interference to a modern (e.g., surface modem 310) that transmitted the modulated signal. The modem can use the data to dynamically calibrate a frequency, a bandwidth, or a bit allocation of a subsequently modulated signal.

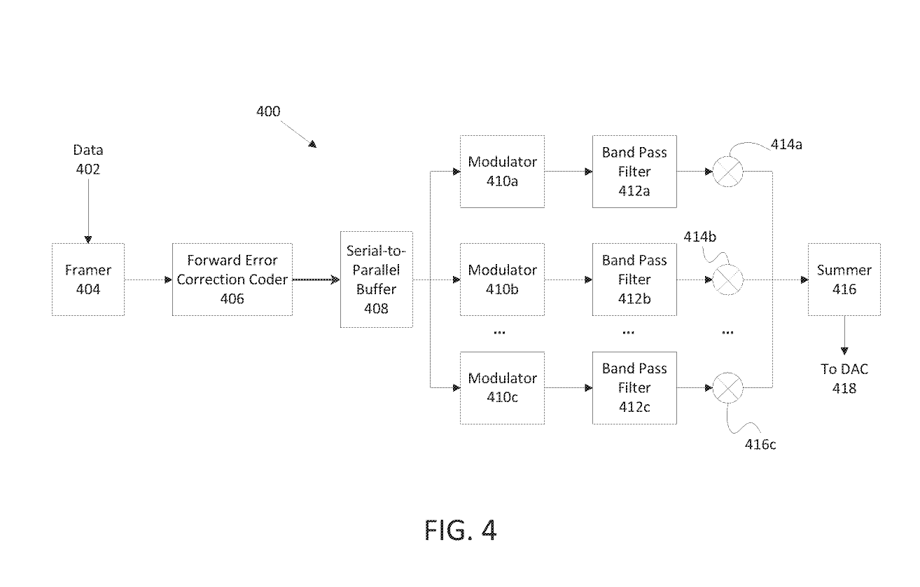

FIG. 4 is a block diagram of an example of a transmitter 400 used in a digital telemetry system. The transmitter 400 can include a framer 404, forward error correction (“FEC”) coder 406, serial-to-parallel buffer 408, modulators 410a-c, band pass filters 412a-c, up-converters 414a-c, and a summer 416.

The framer 404 can receive data 402 for transmission and arrange the data 402 into framed data The framer 404 can further include a header and cyclic redundancy check (“CRC”) information as part of the framed data The FEC coder 406 can be communicatively coupled to the framer 404 for receiving the framed data The FEC coder 406 can add redundancy into the framed data to allow a receiver to detect and correct some errors without a retransmission. A serial-to-parallel buffer 408 can be communicatively coupled to the FEC coder 406 for receiving a stream of framed data and splitting the stream into multiple parallel streams based on an allocation of bits per symbol. The modulators 410a-c can each be communicatively coupled to the serial-to-parallel buffer 408 for receiving one of the parallel streams. The modulators 410a-c can convert the framed data into complex baseband data based on a constellation mapping of a selected modulation scheme. For example, the modulation scheme can include multi-band QAM. The band pass filters 412a-c can each be communicatively coupled to a modulator 410a-c for receiving the modulated data streams. The band pass filters 412a-c can perform pulse shaping on the modulated data streams. Each of the up-converters 414a-c can be communicatively coupled to a band pass filter 412a-c for receiving a pulse shaped modulated data stream and can up-convert each to a corresponding carrier frequency. The summer 416 can be communicatively coupled to the up-converters 414a-c for receiving the up-converted modulated data streams and summing the signals to create a modulated signal. The summer 416 can transmit the modulated signal to a DAC 418 for transmission to a receiver.

In some aspects, the transmitter 400 can use channel analysis to dynamically calibrate bit allocation. For example, to determine an improved bit allocation for each band used in a multi-band QAM digital telemetry system, the digital telemetry system can evaluate symbol variations between an original modulated signal transmitted by the transmitter 400 and a modified modulated signal received at a receiver. The receiver can observe the symbol variations and communicate the data about the variations to the transmitter 400. In some examples, symbol variation can be observed during an initialization of the digital telemetry system. Errors in decoding a symbol can arise due to variation in the recovered symbol and can be captured and analyzed statistically during a decoding of a predetermined sequence of symbols as part of a calibration process. In some examples, a variation can be modeled as a Gaussian random variable and the symbol error rate can be calculated as a probability of detecting the nearest neighboring symbol in a constellation map. Let r(k) be a recovered k-th symbol, then r(k) can be represented as:

$$r ( k ) = \frac{1}{a} ( {s}_{J} ( k ) + {js}_{Q} ( k ) ) + n ( k )$$

where {sₗ(k), s_{Q}(k)} is the symbol and the notation (1/a) denotes the attenuation factor. The recovered symbol variation n(k) can be modeled as a complex Gaussian random variable with zero mean and a standard deviation, φ. The recovered symbol can follow the complex Gaussian random variable with mean, μ=1/a and the standard deviation, φ. The following table depicts an example of relationships between a standard deviation and a symbol error rate (“SER”).

| Modulation | μ > 2σ | μ > 3σ | μ > 4σ | μ > 8σ |
|---|---|---|---|---|
| 4-QAM | SER < 4.55 × 10⁻² | SER < 2.7 × 10⁻³ | SER < 6.33 × 10⁻⁵ | SER < 5.73 × 10⁻⁷ |
| (QPSK) | | | | |
| 16-QAM | SER < 1.36 × 10⁻¹ | SER < 8.1 × 10⁻³ | SER < 1.9 × 10⁻⁴ | SER < 1.72 × 10⁻⁶ |
| 32-QAM | SER < 2.27 × 10⁻¹ | SER < 1.35 × 10⁻² | SER < 3.17 × 10⁻⁴ | SER < 2.87 × 10⁻⁶ |
| 64-QAM | SER < 3.18 × 10⁻¹ | SER < 1.89 × 10⁻² | SER < 4.43 × 10⁻⁴ | SER < 4.01 × 10⁻⁶ |

Assuming that the nearest neighboring symbol differs by only one bit, the bit error rate (“BER”) can be calculated as a function of the SER:

$$BER \approx \frac{1}{b} \times SER$$

where h is the number of bits per symbol. For example, to satisfy a constraint for a BER less than 10⁻⁶ or a SER less than 4×10⁻⁶, the separation between the mean and standard deviation for a 16-QAM single band modulation can be μ>8φ. In an example using multi-band QAM, the overall BER can be the multiplication of the BER across the used band.

In some aspects, the transmitter 400 can dynamically allocate bits to satisfy a BER or a SER. Dynamic bit allocation can include varying the bits communicated in each frequency band of a modulated signal. On-the-fly adjustments for bit allocation may be performed when the channel response is dynamic. For example, on-the-fly calibrating of the digital telemetry system may be performed when the interference is not constant. In some examples, on-the-fly bit allocation can be implemented by repeating a channel analysis process (e.g., sending training symbols) at regular intervals. In additional or alternative examples, on-the-fly adjustments to bit allocation can be made based on data from a receiver during regular transmission.

Although not depicted in FIG, 4. a transmitter can include an analog low pass filter. In some aspects, the digital-to-analog converter 418 can be included as part of a transmitter. In additional or alternative aspects, the transmitter 400 can include a digital signal processor or the transmitter 400 can be communicatively coupled to a digital signal processor. In additional or alternative aspects, the transmitter 400 can be part of a surface modem in a telemetry-system for transmitting instruction to a downhole tool. In additional or alternative aspects, the transmitter 400 can be part of a modem that is positioned downhole and coupled to a downhole tool for transmitting tool data to a surface modem.

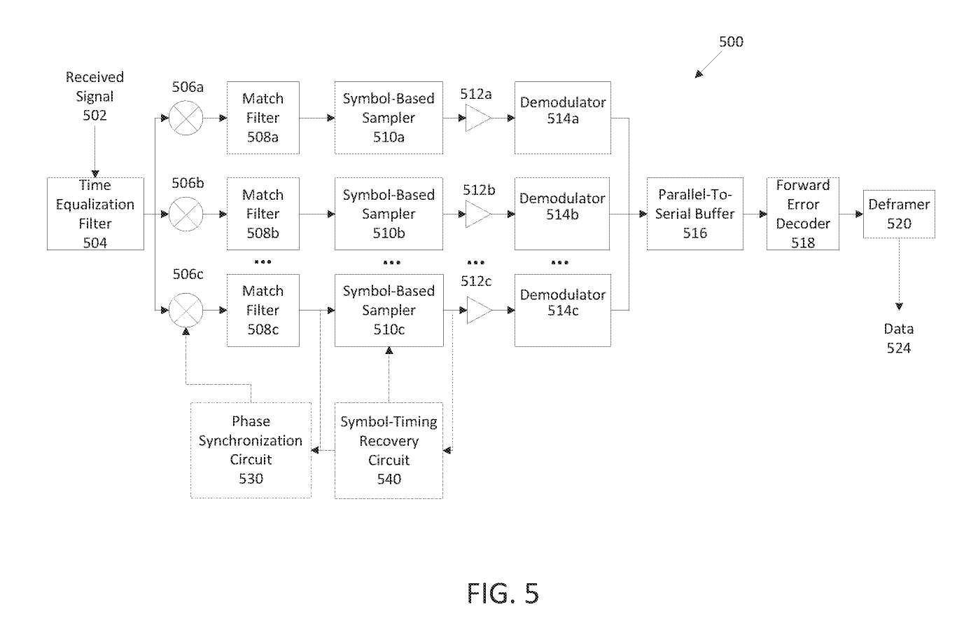

FIG. 5 is a block diagram of an example of a receiver 500 in a digital telemetry system. The receiver can include a time equalization filter 504, down-converters 506a-c, match filters 508a-c, symbol-based samplers 510a-c, amplitude multipliers 512a-c, demodulators 514a-c, a parallel-to-serial buffer 516, a forward error decoder 518, and a defratner 520.

The time equalization filter 504 can apply an inverse of the channel impulse response to the received signal 502 to compensate for channel effects. The output of the time equalization filter 504 can pass through down-converters 506a-c based on carrier frequency and then pass through match filters 508a-c and symbol-based samplers 510a-c. In some aspects, the received signal 502 can be down-converted to a complex baseband signal and convolved with a template based on a pulse shaping waveform. In some examples, the phase offset and timing offset used by the symbol-based samplers 510a-c can be determined during a calibration process. In additional or alternative aspects, the received signal can pass through a feedback loop that includes a phase synchronization circuit 530 and a symbol-timing-recovery circuit 540 to jointly determine a phase offset and timing offset.

The received signal 502 can further pass through amplitude multiplier 512a-c to compensate for the effects of attenuation that can occur as a signal propagates through a communication medium (e.g., cable attenuation). The adjustment factor used by amplitude multiplier 512a-c can be defined as the frequency equalization multiplier (“FEQ”) and can be obtained as part of a calibration process. The received signal 502 can be demodulated by demodulators 514a-c to generate streams of binary data The binary data from each band of the received signal 502 can be combined by the parallel-to-serial buffer 516 to recover an original bit stream. The original bit stream can pass through forward error decoder 518 to detect and correct errors. Deframer 520 can perform a CRC check, remove a header, and extract the data 524. An inaccurate estimate of the phase offset and timing offset can increase the data error rate.

In some aspects, carrier phase synchronization and symbol-timing recovery can be performed jointly by the receiver 500 to determine the phase offset and timing offset. Jointly performing the phase synchronization and symbol-timing recovery can include passing the received signal 502 through the feedback loop with phase synchronization circuit 530 and symbol-timing recovery circuit 540. In some examples, the phase synchronization circuit 530 can use an estimated symbol timing to estimate a phase offset, and the symbol-timing recovery circuit 540 can use the estimated phase offset to update the estimated symbol timing.

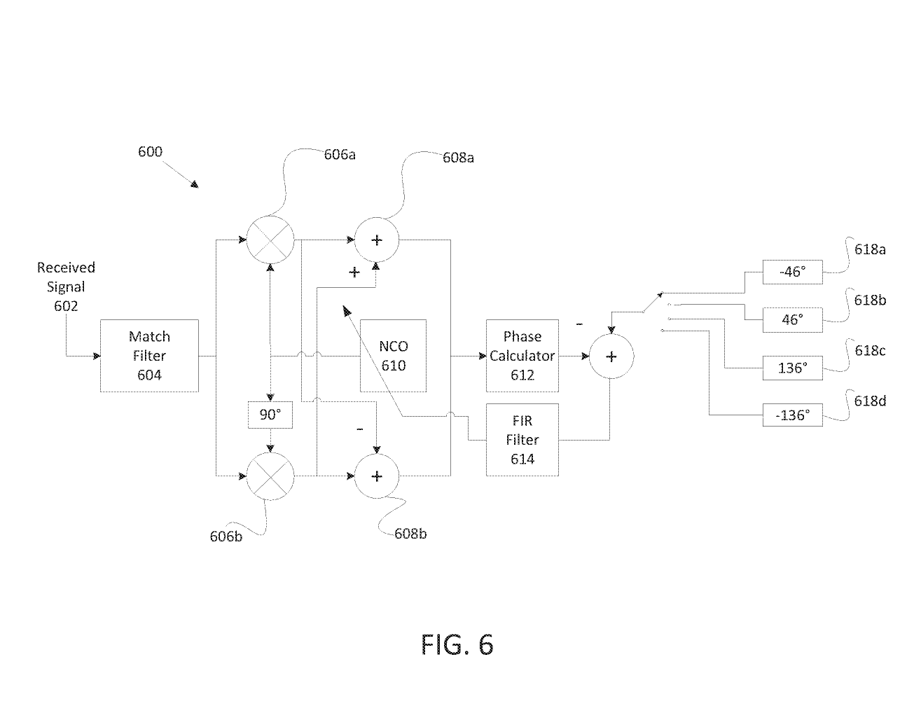

FIG. 6 is a block diagram of an example of a decision feedback-based synchronization circuit 600. In some aspects, a decision feedback-based synchronization circuit is a Costas Loop for tracking the carrier phase 618a-d of a received signal 602. The decision feedback-based synchronization circuit can include a numerically controlled oscillator (“NCO”) 610. The NCO 610 is able to generate waveforms with a precise frequency based on a predefined parameter and can be free from any jitter. Digital implementation of tracking can be achieved by adopting an iterative approach, where the phase of NCO 610, which can be denoted as 4(n), is continuously updated at the start of the nth iteration. The received voltage at sample index n is first processed by a match filter 604, followed by a phase correction from a phase corrector 606a-b based on an output from the NCO 610 in the previous iteration. The difference of a received phase y(n) and a nearest defined QPSK symbol phase s_{QPSK}(K) 618a-d is computed by a phase calculator 612 and fed into a finite impulse response (“FIR”) filter 614, which stores the phase errors for the most recent L samples. The phase of the NCO 610 for the next iteration is updated based on the output of the FIR filter c(n). Let vl(n) and vQ(n) denote the in-phase 608a component and out-of-phase 608b component of the down-converted voltage given Φ(n) at the nth sample, thus:

$$\begin{matrix}φ ( n ) = φ ( n - 1 ) + μ ɛ ( n - 1 ) & ( 1 ) \\ x ( n ) = y ( n ) - {s}_{QPSK} ( κ ) & ( 2 ) \\ ɛ ( n ) = {\sum }_{l = 0}^{L - 1} {a}_{l} x ( n - l ) \\ where κ = {argmin}_{k} \vert y ( n ) - {s}_{QPSK} ( k ) \vert , y ( n ) = {tan}^{- 1} ( \frac{{v}_{Q} ( n )}{{v}_{l} ( n )} ) and \\ {s}_{QPSK} = \{ - \frac{3 π}{4} , - \frac{π}{4} , \frac{π}{4} , \frac{3 π}{4} \} . & ( 3 )\end{matrix}$$

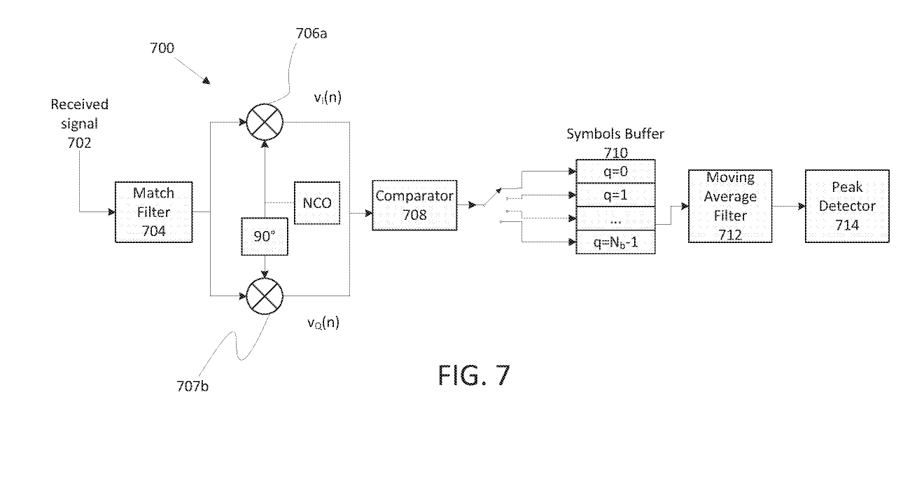

FIG. 7 is a block diagram of an example of a symbol-timing recovery circuit 700 for performing symbol-timing recovery. The symbol-timing recovery circuit 700 can search for the corrective timing offset within a symbol period for demodulation purposes. The optimal symbol sampling time can ensure the highest signal-to-noise ratio (“SNR”) during demodulation. The symbol-timing recovery circuit 700 can include a match filter 704 and down-converters 706a-b for processing the received signal 702. In some aspects, a sampling rate can be set sufficiently high to allow for timing offset estimation, which can be digitally implemented by searching for an optimal sampling index from all samples of one symbol. In sonic examples, the error due to time quantization can be negligible.

The quantized symbol timing estimate based on M transmitted symbols can be computed as follows:

$$\hat{τ} = ( {argmax}_{0 \leq q \leq {N}_{b} - 1} \underbrace{{\sum }_{m = 0}^{M - 1} \vert {v}_{l} ( n - {mN}_{b} ) + {jv}_{Q} ( n - {mN}_{b} ) \vert}_{j ( q )} ) {T}_{s} \qquad ( 4 )$$

where q=n mod N_{b}, the qth sample of a symbol. The index m and n are the symbol index and sample index, respectively. Tₛ is the sampling interval and N_{b} is the number of samples per symbol. A search for a maximum sample index can be implemented by a comparator 708 with differential operators over one symbol period.

A symbol butler 710 can store each sample index of all the previous M transmitted symbols. A moving filter 712 can allow a peak detector 714 to evaluate a cost function J(q) on each sample index of all the previous M transmitted symbols. For every cost function, the peak can be identified when the following conditions are satisfied:

$$\{ \begin{matrix}J ( q - 1 ) - J ( q ) > 0 \\ J ( q - 1 ) - J ( q - 2 ) > 0\end{matrix} \qquad ( 5 )$$

where the maximum occurs at index (q-1) of a symbol, and therefore the quantized symbol-timing offset estimate is (q-1)Tₛ. If the search reaches the end without any peak identified, which can be described as q=N_{b}1 and J(q)-J(q-1)>0, then index q=N_{b}−1 can be determined to be the corrective timing offset.

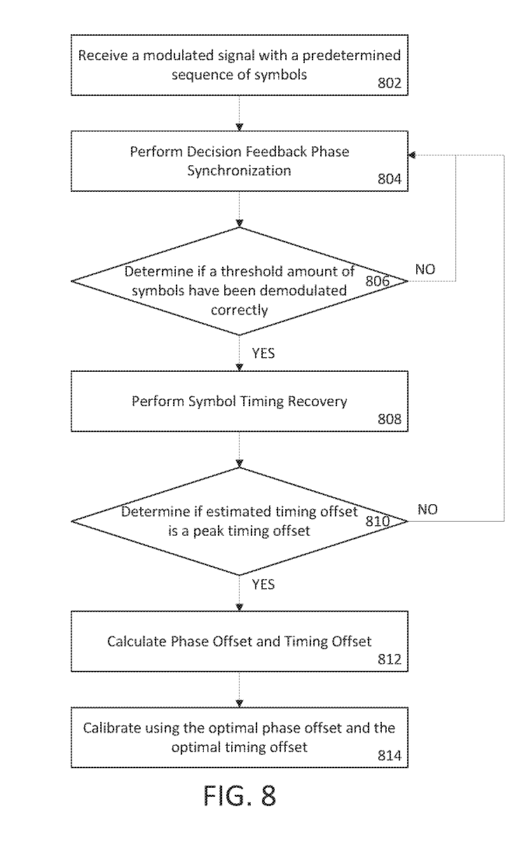

FIG. 8 is a flow chart of an example of a process for jointly performing carrier phase synchronization and symbol-timing recovery for a digital telemetry system. In some aspects, the process is executed in a processing device or demodulator at a surface modem or downhole modem in a digital telemetry system. Jointly performing phase synchronization and symbol-timing recovery can exploit additional information available from greater-than-symbol-rate sampling. The process can also result in a faster convergence rate and better reliability.

In block 802, a receiver in a digital telemetry system receives a modulated signal with a predetermined sequence of transmitted symbols. The receiver can demodulate the modulated signal to generate a sequence of received symbols. In some aspects, carrier phase synchronization and symbol-timing recovery can be performed jointly during an initialization of a digital telemetry system. For example, a modulated signal with a predetermined sequence of training symbols can be transmitted from a first modem in a digital telemetry system to a second modem.

In block 804, phase synchronization can be performed to track differences in phase between the received symbols and the transmitted symbols. In some aspects, an estimated phase offset can be updated based on the tracked differences. In some examples, a decision feedback-based Costas Loop, as illustrated in FIG. 6, is used to perform the phase synchronization.

In block 806, a counter function can determine if a threshold amount of transmitted symbols have been demodulated correctly. The counter function can count the number of correct demodulations of transmitted symbols that occurred in the phase synchronization using the estimated symbol timing. In some examples, the threshold amount can be 50% of the transmitted symbols to check that a majority of the training symbols were correctly observed as received symbols. In additional or alternative aspects, the threshold amount can be at least 90%. In some aspects, if the count is less than the threshold amount the estimated timing offset is adjusted and phase synchronization is re-performed.

In block 808, symbol-timing recovery can be performed by evaluating each of the received symbols at a series of sampling indices. An optimal sample index for all symbols can be determined based on a comparison of computed symbol values for each received symbol at each sample index. In some examples, symbol-timing recovery can be performed by passing a received signal through the symbol-timing recovery circuit illustrated in FIG. 7. In block 810, the symbol offset is evaluated to determine if a corrective timing offset can be calculated. If a peak is not found, the synchronization process can be restarted with an adjusted timing offset.

In block 812, the corrective phase offset and the corrective timing offset can be calculated based on the estimated phase offset and estimated timing offset. In block 814, the receiver can be calibrated using the corrective phase offset and the corrective timing offset to improve the accuracy and efficiency of obtaining transmitted data from a subsequently modulated signal. In some aspects, the subsequently modulated signal can include a modulated signal received by the receiver subsequent in time to the modulated signal used to determine the corrective phase offset and the corrective timing offset. In additional or alternative aspects, a subsequently modulated signal can include a modulated signal received by the receiver subsequent in time to the receiver being calibrated to use the corrective phase offset and the corrective timing offset for demodulation.

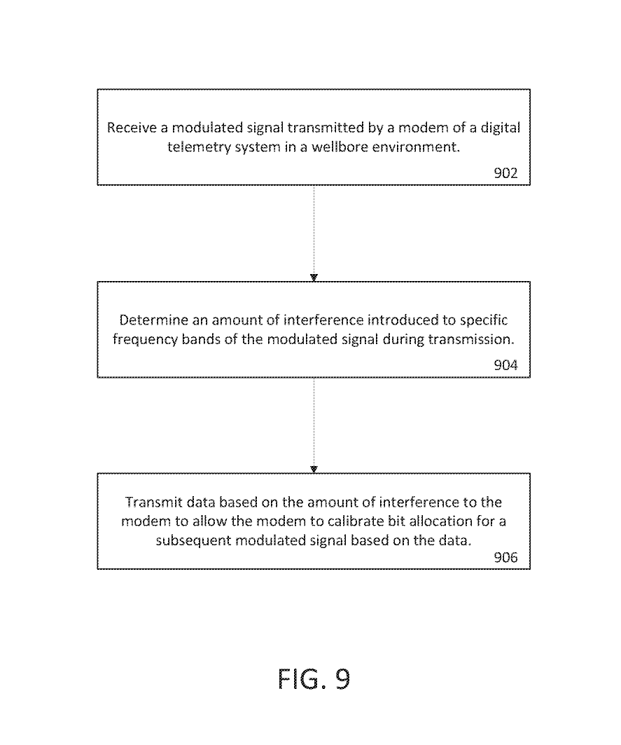

FIG. 9 is a flow chart of an example of a process for calibrating a digital telemetry system through channel analysis and modulation adjustments. In block 902, a modulated signal is received from a modem in a digital telemetry system in a wellbore environment. In some aspects, the modulated signal can be part of a training or initialization process. In additional or alternative aspects, the modulated signal can be part of regular telemetry transmission. In some examples, the modulated signal can be received by a receiver in a surface modem positioned at a surface of a wellbore in the wellbore environment. In additional or alternative examples, the modulated signal can be received by a receiver in a downhole modem positioned in a wellbore in the wellbore environment.

In block 904, an amount of interference introduced to specific frequency bands of the modulated signal during transmission is determined. In some aspects, the interference can be attenuation due to a length of a cable or depth of mud used as a communication medium for the digital telemetry system. In additional or alternative aspects, the interference can be environmental noise such as a downhole motor communicatively. In some aspects, interference can be determined by capturing the received spectrum during a silent period when no signals are being communicated over the communication medium. In additional or alternative aspects, interference can be determined by comparing expected signals with received signals.

In block 906, data based on the amount of interference is transmitted to the modem. In some aspects, the modem can use the data to adjust frequency, bandwidth, or bit allocation of a subsequently modulated signal. In some examples, the data can include instructions to adjust the subsequently modulated signals. In some aspects, subsequently modulated signals can include signals modulated subsequent in time to the modem being calibrated based on the interference data In additional or alternative aspects, subsequently modulated signals can include modulated signals transmitted subsequent in time to the modem receiving the data based on the amount of interference.

The modulated signal can be modulated using multi-band QAM, and the data transmit to the modem can further include instructions for grouping neighboring sub-bands. In some aspects, the data can be used to dynamically allocate bits to each frequency sub-band and shift the carrier frequency of the sub-bands to avoid overlapping with interfering frequency. In some aspects, the method can further include eliminating processing by receivers of unused sub-bands that serve as guards between uplink and downlink.

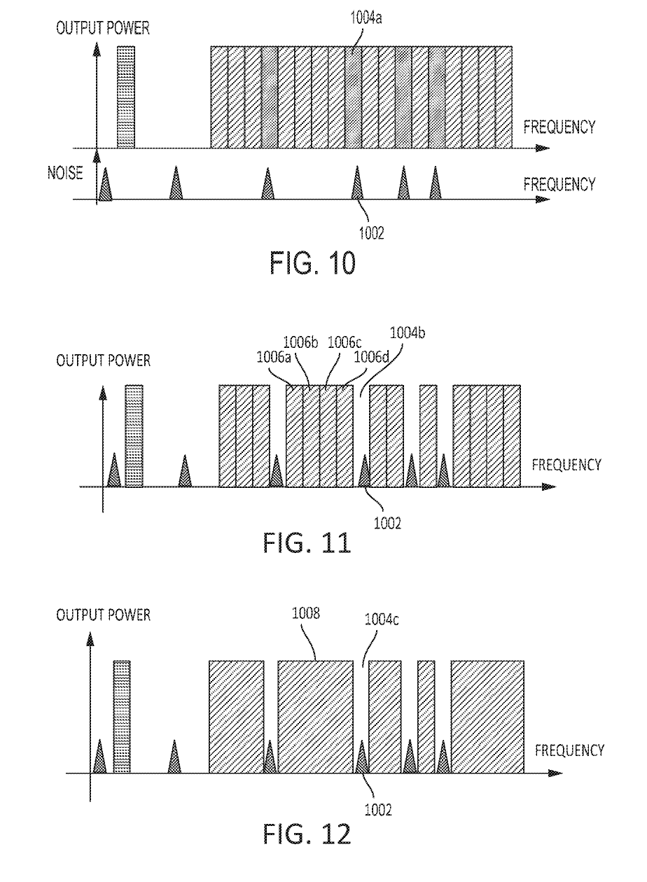

FIGS. 10-12 are graphs showing frequency spectrums for signals transmitted by a digital telemetry system at different stages of a calibration process. The digital telemetry system can use a multi-band QAM scheme. In some aspects, calibrating a digital telemetry system can be initiated upon the detection of interference in a specific frequency of a frequency spectrum used to communicate data In FIG. 10, the environmental noise 1002 can be detected as interference in a frequency band 1004a In some examples, environment noise can be detected during initialization of a digital telemetry system. In additional or alternative examples, environment noise can be detected on-the-fly. For example, a digital telemetry system can compute a received spectrum during a silent duration between frames to determine environmental noise. FIG. 10 can depict a multi-band QAM telemetry system configured for a maximum achievable data rate for uplink with 18-band 16 QAM and single band 16-QAM for downlink. The environmental noise 1002 (e.g., the presence of motor noise or tractor noise during downhole operation) can reduce the efficiency and reliability of the digital telemetry system.

FIG. 11 depicts the frequency spectrum of FIG. 10 after a calibration process has reconfigured the digital telemetry system to skip the bands 1004b that overlap with the environmental noise 1002. Multi-band QAM can allow the digital telemetry system to be further calibrated as illustrated by the frequency spectrum in FIG. 12. In some examples, a digital telemetry system can group neighboring sub-bands 1006a-d to form a single sub-band 1008. Reducing the number of sub-band can reduce the processing requests placed on a receiver. Calibrating a digital telemetry system can also reduce unnecessary processing of unused sub-bands that serve as guard bands between uplink and downlink.

In some aspects, calibrating a digital telemetry system is provided according to one or more of the following examples:

Example #1: A device can include a receiver, a processing device, and a non-transitory computer-readable medium. The receiver can be positioned in a digital telemetry system to receive a modulated signal with a predetermined sequence of transmitted symbols. The processing device can be communicatively coupled to the receiver. The non-transitory computer-readable medium can include instructions that can be executed by the processing device for causing the processing device to perform carrier phase synchronization and symbol-timing recovery jointly on the modulated signal by using an estimated timing offset from the symbol-timing recovery to update an estimated phase offset and by using the estimated phase offset from the carrier phase synchronization to update the estimated timing offset. The instructions can be further executed for causing the processing device to determine a corrective phase offset and a corrective timing offset from the estimated phase offset and the estimated timing offset. The instructions can be further executed for causing the processing device to calibrate the receiver to demodulate a subsequently modulated signal based on the corrective phase offset and the corrective timing offset.

Example #2: The device of Example #1, can feature the digital telemetry system positioned in a wellbore environment. The device can further feature the receiver including a demodulator to demodulate the modulated signal and determine an amount of interference introduced to specific frequency bands of the modulated signal during transmission. The device can further include a transmitter communicatively coupled to the receiver to transmit data based on the amount of interference to a modem that transmitted the modulated signal. The data can be used by the modem for dynamically calibrating a bit allocation of the subsequently modulated signal.

Example #3: The device of Example #1, can feature the receiver including a demodulator to demodulate the modulated signal based on the estimated timing offset to generate a received sequence of received symbols. The processing device can further include a decision feedback-based phase synchronization circuit, a counter, a symbol-timing recovery circuit, and a controller. The decision feedback-based phase synchronization circuit can be communicatively coupled to the demodulator to track differences in phase between each received symbol in the received sequence of received symbols and a corresponding transmitted symbol in the predetermined sequence of transmitted symbol. The decision feed-back phase synchronization circuit can also update the estimated phase offset based on the differences in phase. The counter can be communicatively coupled to the decision feedback-based phase synchronization circuit to determine a number of received symbols. The counter can further determine if the number is less than a threshold amount of the transmitted symbols to adjust the estimated timing offset. The symbol-timing recovery circuit can be communicatively coupled to the decision feedback-based phase synchronization circuit to determine a symbol value for each received symbol at a sample index. The symbol-timing recovery circuit can further compare the symbol value for each received symbol, and determine if a peak is not found to adjust the estimated timing offset. The controller can determine the corrective phase offset and the corrective timing offset from the estimated phase offset and the estimated timing oft'set and calibrate the receiver to use the corrective phase offset and the corrective timing offset for demodulating the subsequently modulated signal.

Example #4: The device of Example #3, can feature the threshold amount being at least 90% of the transmitted symbols.

Example #5: The device of Example #1, can feature the device being a downhole modem positioned in a wellbore and communicatively coupled to a downhole tool. The device can transmit data collected from the downhole tool to a surface modem positioned at a surface of the wellbore.

Example #6: The device of Example #1, can feature the device being a surface modem positioned at a surface of a wellbore to transmit commands to a downhole modem positioned in the wellbore to be delivered to one or more logging tools.

Example #7: A method can include receiving a modulated signal from a modem in a digital telemetry system, the modulated signal can include a predetermined sequence of transmitted symbols. The method can further include performing carrier phase synchronization and symbol-timing recovery jointly by using an estimated timing offset from the symbol-timing recovery to update an estimated phase offset and using the estimated phase offset to update the estimated timing offset. The method can further include calibrating the digital telemetry system to use a corrective phase offset and a corrective timing offset for demodulating modulated signals transmitted by the modem based on the estimated phase offset and the estimated timing offset.

Example #8: The method of Example #7, can further include determining an amount of interference introduced to specific frequency bands of the modulated signal during transmission. The method can further include transmitting data based on the amount of interference to the modem to allow the modem to dynamically calibrate bit allocation for a subsequently modulated signal based on the data.

Example #9: The method of Example #7, can feature performing the carrier phase synchronization and the symbol-timing recovery jointly including demodulating the modulated signal based on the estimated timing offset to generate a sequence of received symbols. Performing the carrier phase synchronization and the symbol-timing recovery jointly can further include tracking a difference in phase between each received symbol in the sequence of received symbols and a corresponding transmitted symbol in the predetermined sequence of transmitted symbols. The estimated phase offset can be updated based on the difference in phase. Performing the carrier phase synchronization and the symbol-timing recovery jointly can further include searching for a peak by evaluating each received symbol at a sample index to determine a symbol value and comparing each symbol value. Performing the carrier phase synchronization and the symbol-timing recovery jointly can further include re-performing the carrier phase synchronization and the symbol-timing recovery jointly based on a new timing offset if a number of received symbols is less than a threshold amount of transmitted symbols or if the symbol-timing recovery failed to find the peak.

Example #10: The method of Example #9, can feature tracking the difference in phase being performed by passing the modulated signal through a decision feedback-based Costas loop.

Example #11: The method of Example #9, can feature the threshold amount of transmitted symbols being at least 90% of the transmitted symbols.

Example #12: The method of Example #9, can feature a length of a transmitted symbol being chosen to ensure that a phase estimate converges before an end of the sequence of transmitted symbols.

Example #13: A device can include a receiver and a transmitter. The receiver can be in a digital telemetry system positioned in a wellbore environment to receive a modulated signal transmitted by a modem. The receiver can include a demodulator for demodulating the modulated signal and determining an amount of interference introduced to specific frequency bands of the modulated signal during transmission. The transmitter can be communicatively coupled to the receiver to transmit data based on the amount of interference to the modem for use by the modem to dynamically calibrate bit allocation for a subsequently modulated signal.

Example #14: The device of Example #13, can feature the modulated signal including a predetermined sequence of transmitted symbols. The device can further include a processing device communicatively coupleable to the receiver. The device can further include a non-transitory computer-readable medium in which instructions that can be executed by the processing device are stored for causing the processing device to perform carrier phase synchronization and symbol-timing recovery jointly on the modulated signal by using an estimated timing offset from the symbol-timing recovery to update an estimated phase offset. The instructions can further be executed to cause the processing device to use the estimated phase offset from the carrier phase synchronization to update the estimated timing offset. The instructions can further be executed to cause the processing device to calibrate the receiver using a corrective phase offset and a corrective timing offset based on the estimated phase offset and the estimated timing offset.

Example #15: The device of Example #13, can further include a processing device communicatively coupled to the receiver. The device can further include a non-transitory computer-readable medium in which instructions that can be executed by the processing device are stored for causing the processing device to determine a bit allocation and determine a sub-band grouping. The data can include instruction to the modem to transmit the subsequently modulated signal using the bit allocation and sub-band grouping.

Example #16: The device of Example #13, can further include a scanner for receiving a noise signal during a silent duration in-between transmission of frames. The data can be based on the noise signal.

Example #17: The device of Example #13, can feature the modern positioned in a wellbore and communicatively coupled to a downhole tool. The device can be positioned at a surface of the wellbore. The transmitter can transmit commands to the modem over a wireline.

Example #18: The device of Example #13, can feature the modem positioned at a surface of a wellbore. The device can be positioned downhole and communicatively coupled to a downhole tool. The transmitter can transmit tool information to the modem over a wireline.

Example #19: A method can include receiving a modulated signal transmitted by a modem of a digital telemetry system in a wellbore environment. The method can further include determining an amount of interference introduced to specific frequency bands of the modulated signal during transmission. The method can further include transmitting data based on the amount of interference to the modem to allow a subsequently modulated signal from the modem to have a bit allocation calibrated based on the data.

Example #20: The method of Example #19, can feature the modulated signal including a predetermined sequence of transmitted symbols. The method can further include performing carrier phase synchronization and symbol-timing recovery jointly on the modulated signal by using an estimated timing offset from the symbol-timing recovery to update an estimated phase offset and using the estimated phase offset to update the estimated timing offset. The method can further include calibrating the digital telemetry system to use a corrective phase offset and a corrective timing offset based on the estimated phase offset and the estimated timing offset for demodulating modulated signals received from the modem.

Example #21: The method of Example #19, can feature the modulated signal being modulated using a multi-band quadrature amplitude modulation. The data can include instructions for the bit allocation and a grouping of neighboring sub-bands.

Example #22: The method of Example #19, can further include scanning for a noise signal during a silent duration in between receiving frames from the modern. The data can be based on the noise signal.

Example #23: The method of Example #19, can further include eliminating processing of unused sub-bands by the receiver that serve as guards between uplink and downlink.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A device comprising:
a receiver positionable in a digital telemetry system to receive a modulated signal comprising a predetermined sequence of transmitted symbols;
a processing device communicatively coupleable to the receiver; and
a non-transitory computer-readable medium in which instructions executable by the processing device are stored for causing the processing device to:
perform carrier phase synchronization and symbol-timing recovery jointly on the modulated signal by using an estimated timing offset from the symbol-timing recovery to update an estimated phase offset;
use the estimated phase offset from the carrier phase synchronization to update the estimated timing offset;
determine a corrective phase offset and a corrective timing offset from the estimated phase offset and the estimated timing offset; and
calibrate the receiver to demodulate a subsequently modulated signal based on the corrective phase offset and the corrective timing offset.

2. The device of claim 1, wherein the digital telemetry system is positionable in a wellbore environment, and the receiver comprises a demodulator to demodulate the modulated signal and determine an amount of interference introduced to specific frequency bands of the modulated signal during transmission, the device further comprising:
a transmitter communicatively coupleable to the receiver to transmit data based on the amount of interference to a modem that transmitted the modulated signal, the data being useable by the modem for dynamically calibrating a bit allocation of the subsequently modulated signal.

3. The device of claim 1, wherein the receiver comprises a demodulator to demodulate the modulated signal based on the estimated timing offset to generate a received sequence of received symbols, and wherein the processing device comprises:
a decision feedback-based phase synchronization circuit communicatively coupleable to the demodulator to track differences in phase between each received symbol in the received sequence of received symbols and a corresponding transmitted symbol in the predetermined sequence of transmitted symbols, and for updating the estimated phase offset based on the differences in phase;
a counter communicatively coupleable to the decision feedback-based phase synchronization circuit to determine a number of received symbols, and for determining if the number is less than a threshold amount of the transmitted symbols to adjust the estimated timing offset;
a symbol-timing recovery circuit communicatively coupleable to the decision feedback-based phase synchronization circuit to determine a symbol value for each received symbol at a sample index, for comparing the symbol value for each received symbol, and for determining if a peak is not found to adjust the estimated timing offset; and
a controller for determining the corrective phase offset and the corrective timing offset from the estimated phase offset and the estimated timing offset and calibrating the receiver to use the corrective phase offset and the corrective timing offset for demodulating the subsequently modulated signal.

4. The device of claim 3, wherein the threshold amount is at east 90% of the transmitted symbols.

5. The device of claim 1, wherein the device is a downhole modem positionable in a wellbore and communicatively coupleable to a downhole tool, for transmitting data collected from the downhole tool to a surface modem positionable at a surface of the wellbore.

6. The device of claim 1, wherein the device is a surface modem positionable at a surface of a wellbore for transmitting commands to a downhole modem positionable in the wellbore to be delivered to one or more logging tools.

7. A method comprising:
receiving a modulated signal from a modem in a digital telemetry system, the modulated signal comprising a predetermined sequence of transmitted symbols;
performing carrier phase synchronization and symbol-timing recovery jointly by using an estimated timing offset from the symbol-timing recovery to update an estimated phase offset and using the estimated phase offset to update the estimated timing offset; and
calibrating the digital telemetry system to use a corrective phase offset and a corrective timing offset for demodulating modulated signals transmitted by the modem based on the estimated phase offset and the estimated timing offset.

8. The method of claim 7, further comprising:
determining an amount of interference introduced to specific frequency bands of the modulated signal during transmission; and
transmitting data based on the amount of interference to the modem to allow the modem to dynamically calibrate bit allocation for a subsequently modulated signal based on the data.

9. The method of claim 7, wherein performing the carrier phase synchronization and the symbol-timing recovery jointly comprises:
demodulating the modulated signal based on the estimated timing offset to generate a sequence of received symbols;
tracking a difference in phase between each received symbol in the sequence of received symbols and a corresponding transmitted symbol in the predetermined sequence of transmitted symbols, and updating the estimated phase offset based on the difference in phase;
searching for a peak by evaluating each received symbol at a sample index to determine a symbol value and comparing each symbol value; and
re-performing the carrier phase synchronization and the symbol-timing recovery jointly based on a new timing offset if a number of received symbols is less than a threshold amount of transmitted symbols or if the symbol-timing recovery failed to find the peak.

10. The method of claim 9, wherein tracking the difference in phase is performed by passing the modulated signal through a decision feedback-based Costas loop.

11. The method of claim 9, wherein the threshold amount of transmitted symbols is at least 90% of the transmitted symbols.

12. The method of claim 9, wherein a length of a transmitted symbol is chosen to ensure that a phase estimate converges before an end of the sequence of transmitted symbols.

13. A device comprising:
a receiver in a digital telemetry system positionable in a wellbore environment to receive a modulated signal transmitted by a modem, and comprising a demodulator for demodulating the modulated signal and determining an amount of interference introduced to specific frequency bands of the modulated signal during transmission; and
a transmitter communicatively coupleable to the receiver to transmit data based on the amount of interference to the modem for use by the modem to dynamically calibrate bit allocation for a subsequently modulated signal.

14. The device of claim 13, wherein the modulated signal comprises a predetermined sequence of transmitted symbols, and the device further comprising:
a processing device communicatively coupleable to the receiver; and
a non-transitory computer-readable medium in which instructions executable by the processing device are stored for causing the processing device to:
perform carrier phase synchronization and symbol-timing recovery jointly on the modulated signal by using an estimated timing offset from the symbol-timing recovery to update an estimated phase offset;
use the estimated phase offset from the carrier phase synchronization to update the estimated timing offset; and
calibrate the receiver using a corrective phase offset and a corrective timing offset based on the estimated phase offset and the estimated timing offset.

15. The device of claim 13, further comprising:
a processing device communicatively coupleable to the receiver; and
a non-transitory computer-readable medium in which instructions executable by the processing device are stored for causing the processing device to determine the bit allocation and determine a sub-band grouping,
wherein the data comprises instructions to the modem to transmit the subsequently modulated signal using the bit allocation and the sub-band grouping.

16. The device of claim 13, further comprising:
a scanner for receiving a noise signal during a silent duration in-between transmission of frames, and wherein the data is further based on the noise signal.

17. The device of claim 13, wherein the modem is positionable in a wellbore and communicatively coupleable to a downhole tool, wherein the device is positionable at a surface of the wellbore, and wherein the transmitter is further for transmitting commands to the modem over a wireline.

18. The device of claim 13, wherein the modem is positionable at a surface of a wellbore, wherein the device is positionable downhole and communicatively coupleable to a downhole tool, and wherein the transmitter is further for transmitting tool information to the modem over a wireline.

19. A method comprising:
receiving a modulated signal transmitted by a modem of a digital telemetry system in a wellbore environment;
determining an amount of interference introduced to specific frequency bands of the modulated signal during transmission; and
transmitting data based on the amount of interference to the modem to allow a subsequently modulated signal from the modem to have a bit allocation calibrated based on the data.

20. The method of claim 19, wherein the modulated signal comprises a predetermined sequence of transmitted symbols, the method further comprising:
performing carrier phase synchronization and symbol-timing recovery jointly on the modulated signal by using an estimated timing offset from the symbol-timing recovery to update an estimated phase offset and using the estimated phase offset to update the estimated timing offset; and
calibrating the digital telemetry system to use a corrective phase offset and a corrective timing offset based on the estimated phase offset and the estimated timing offset for demodulating modulated signals received from the modem.

21. The method of claim 19, wherein the modulated signal is modulated using a multi-band quadrature amplitude modulation and the data comprises instructions for the bit allocation and a grouping of neighboring sub-bands.

22. The method of claim 19, further comprising:
scanning for a noise signal during a silent duration in between receiving frames from the modem, and
wherein the data is further based on the noise signal.

23. The method of claim 19, further comprising:
eliminating processing of unused sub-bands by the receiver that serve as guards between uplink and downlink.
